(19) United States
(12) Patent Application Publication
(10) Pub. No.: US 2017/0113339 A1
(43) Pub. Date: Apr. 27, 2017

(54) MULTI-PURPOSE WRENCH TOOL

(71) Applicant: Yi Cheng LI, Taichung (TW)

(72) Inventor: Yi Cheng LI, Taichung (TW)

(21) Appl. No.: 14/923,463

(22) Filed: Oct. 27, 2015

(51) Int. Cl. B25G 1/00; B25B 13/00

(52) U.S. Cl. CPC B25G 1/005; B25B 13/005

(57) ABSTRACT

A multi-purpose wrench tool includes a main wrench shaft member having one or two screwdriver heads and having a bore formed in the main wrench shaft member, and a rough member formed in the bore of the main wrench shaft member, and an elongated leverage bar includes a rough element formed on one end portion of the elongated leverage bar for engaging into the bore of the main wrench shaft member and for frictionally engaging with the rough member of the main wrench shaft member and for driving the main wrench shaft member with the elongated leverage bar. The elongated leverage bar includes an outer diameter (d) no greater than an inner diameter (D) of the bore of the main wrench shaft member.

### BACKGROUND OF THE INVENTION

1. Field of the Invention

The present invention relates to a two-piece multi-purpose wrench tool, and more particularly to a multi-purpose wrench tool including an elongated leverage bar frictionally engageable with a main wrench shaft member for providing a torque necessary to either tighten or loosen nuts or bolts and for allowing the main wrench shaft member to be solidly and stably and effectively rotated or driven by the elongated leverage bar.

2. Description of the Prior Art

Typical two-piece multi-purpose wrench tools comprise an elongated leverage bar inserted through a bore of a main wrench shaft member to provide a torque necessary to either tighten or loosen nuts or bolts, and normally, the leverage bar has a standard screwdriver head formed at one of its ends to allow for miscellaneous screw driving applications and the convenient removal of hub caps and tires.

For example, U.S. Pat. No. 2,968,980 to Zierold, U.S. Pat. No. 5,685,207 to Hubert, U.S. Pat. No. 6,260,452 to Yu, U.S. Pat. No. 6,901,827 to Yen, and U.S. Pat. No. 7,228,766 to Shyu disclose several of the typical multi-purpose wrench tools each also comprising an elongated leverage bar inserted through a bore of a main wrench shaft member to provide a torque necessary to either tighten or loosen nuts or bolts, and one or more screwdriver heads formed or provided at the ends of the main wrench shaft member to allow for miscellaneous screw driving applications and the convenient removal of hub caps and tires.

However, the attachment or engagement between the main wrench shaft member and the elongated leverage bar is normally anchored or retained or positioned by a spring-biased latch device or the like, and normally, the main wrench shaft member and the elongated leverage bar are smoothly and slidably engaged with each other; i.e., the main wrench shaft member and the elongated leverage bar may not be solidly and stably and frictionally engaged with each other, and the main wrench shaft member and the elongated leverage bar may have a good chance to be slid or moved relative to each other, such that the main wrench shaft member may not be solidly and stably and effectively rotated or driven by the elongated leverage bar.

The present invention has arisen to mitigate and/or obviate the afore-described disadvantages of the conventional multi-purpose wrench tools.

### SUMMARY OF THE INVENTION

The primary objective of the present invention is to provide a multi-purpose wrench tool including an elongated leverage bar engageable with a main wrench shaft member for providing a torque necessary to either tighten or loosen nuts or bolts.

The other objective of the present invention is to provide a multi-purpose wrench tool including an elongated leverage bar frictionally engageable with a main wrench shaft member for allowing the main wrench shaft member to be solidly and stably and effectively rotated or driven by the elongated leverage bar.

In accordance with one aspect of the invention, there is provided a multi-purpose wrench tool comprising a main wrench shaft member including a first screwdriver head provided at a first end of the main wrench shaft member for engaging with a driven element, the main wrench shaft member including a bore formed in an intermediate portion of the main wrench shaft member, and including a rough member provided in the bore of the main wrench shaft member, and an elongated leverage bar including a rough element provided on a first end portion of the elongated leverage bar for engaging into the bore of the main wrench shaft member and for frictionally engaging with the rough member of the main wrench shaft member and for driving the main wrench shaft member with the elongated leverage bar and thus for allowing the main wrench shaft member to be solidly and stably and effectively rotated or driven by the elongated leverage bar.

The elongated leverage bar includes an outer diameter (d) no greater than an inner diameter (D) of the bore of the main wrench shaft member for allowing the first end portion of the elongated leverage bar to be freely engaged into the bore of the main wrench shaft member.

The main wrench shaft member includes an enlarged seat or block provided on the intermediate portion of the main wrench shaft member,

and the bore of the main wrench shaft member is formed in the block of the main wrench shaft member for selectively engaging with the elongated leverage bar.

The main wrench shaft member includes a second screwdriver head formed or provided at a second end of the main wrench shaft member. A distance (S) between the first screwdriver head and the block is no greater than a distance (L) between the second screwdriver head and the block. The elongated leverage bar may include a serrated or rough or knurled hand grip formed or provided on the other end portion of the elongated leverage bar for being frictionally grasped or gripped or held by the user.

The elongated leverage bar includes a key or stop attached thereto for selectively engaging with the main wrench shaft member and for guiding and limiting the elongated leverage bar to move relative to the main wrench shaft member and for allowing the wrench tool to be solidly and stably and effectively actuated or operated by the user.

The elongated leverage bar includes a spring biased projection provided therein for selectively engaging with the rough member of the main wrench shaft member and anchoring the elongated leverage bar to the main wrench shaft member and for preventing the elongated leverage bar from being disengaged or separated from the main wrench shaft member inadvertently.

The bore of the main wrench shaft member is perpendicular to the main wrench shaft member. The rough member of the main wrench shaft member is selected from a threaded element for frictionally engaging with the rough element of the elongated leverage bar, and/or the rough element of the elongated leverage bar is selected from a threaded element for frictionally engaging with the rough member of the main wrench shaft member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a multi-purpose wrench tool in accordance with the present invention;

FIG. 2 is a plan schematic view of the multi-purpose wrench tool in which a portion of the multi-purpose wrench tool has been cut off for showing the inner structure of the multi-purpose wrench tool;

FIG. 3 is a partial plan schematic view illustrating the operation of the multi-purpose wrench tool;

FIG. 4 is another plan schematic view illustrating the main wrench shaft member of the multi-purpose wrench tool in which a portion of the main wrench shaft member has been cut off for showing the inner structure of the main wrench shaft member;

FIG. 5 is an enlarged partial cross sectional view of the multi-purpose wrench tool as shown in FIG. 3;

FIG. 6 is a further plan schematic view illustrating the attachment or engagement between the main wrench shaft member and the elongated leverage bar;

FIG. 7 is an enlarged partial cross sectional view of the multi-purpose wrench tool as shown in FIG. 6; and

FIGS. 8, 9 are plan schematic views illustrating the operation of the multi-purpose wrench tool.

### DETAILED DESCRIPTION OF THE PREFERRED EMBODIMENT

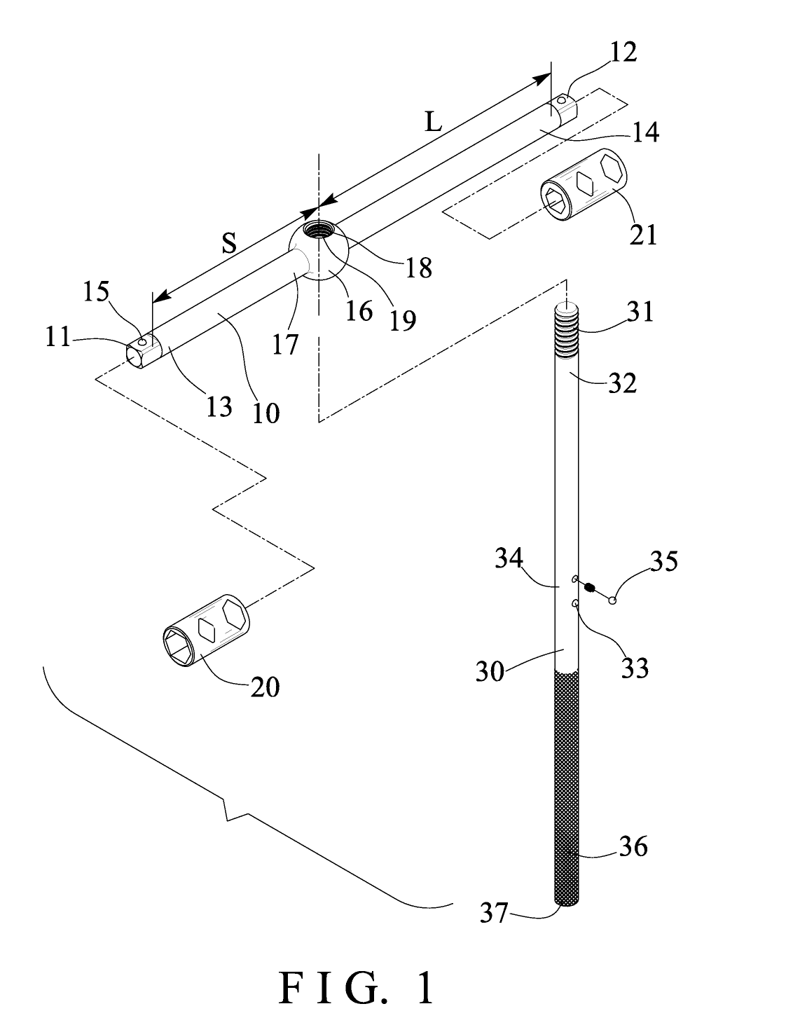

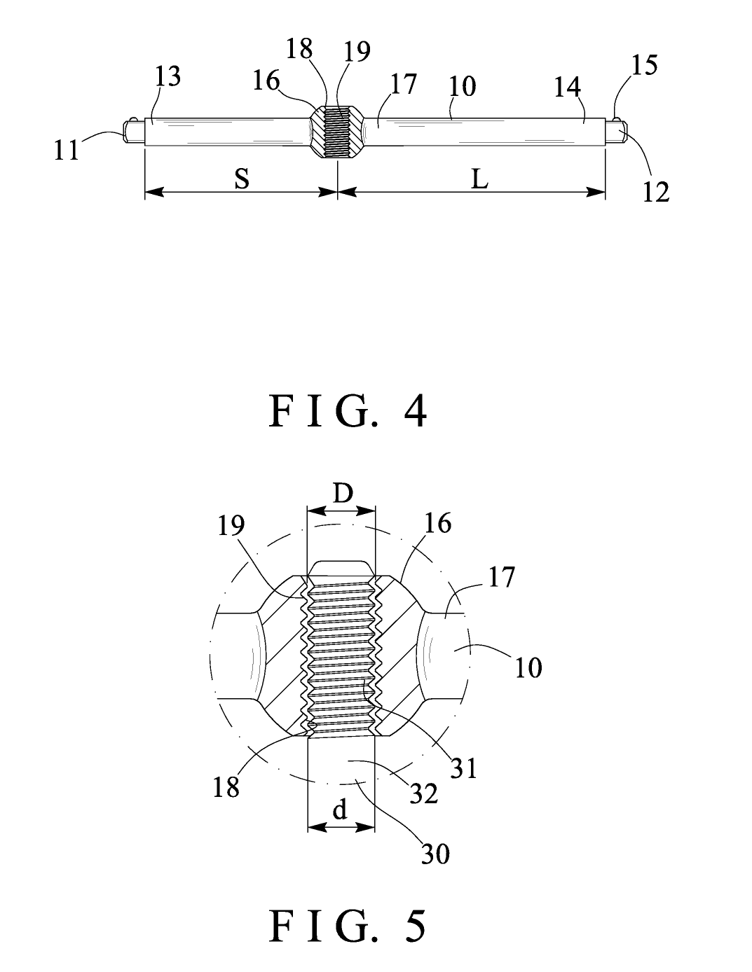

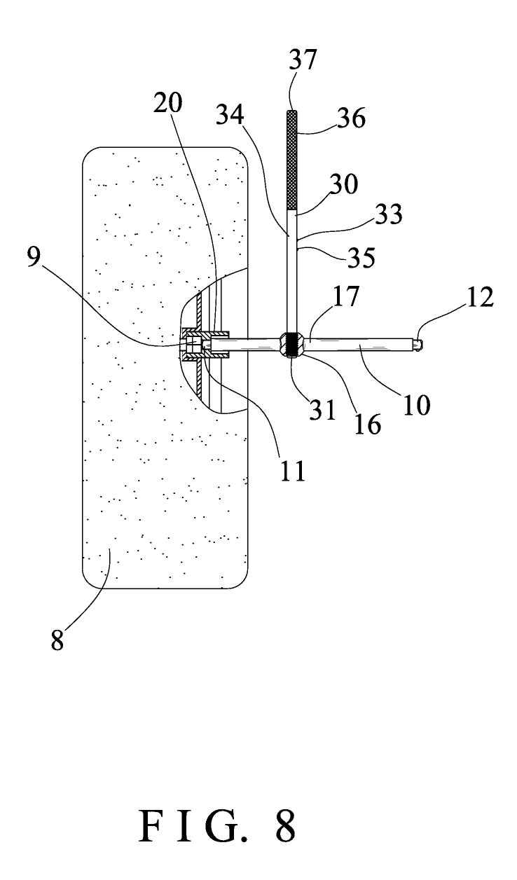

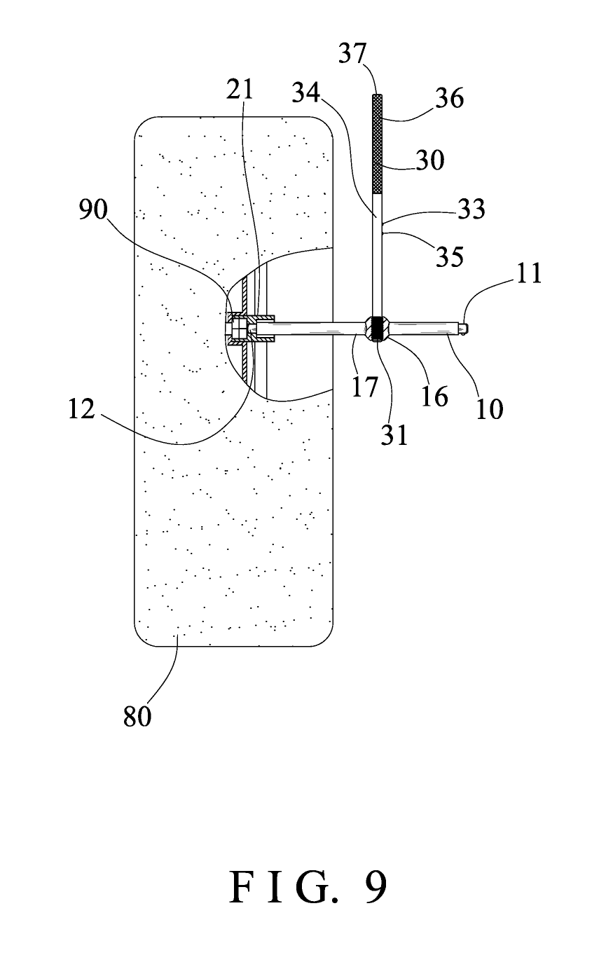

Referring to the drawings, and initially to FIGS. 1-7, a multi-purpose wrench tool in accordance with the present invention comprises a main wrench shaft member 10 including one or more (such as two) driving studs or screwdriver heads 11, 12 formed or provided at the ends 13, 14 of the main wrench shaft member 10 for engaging with socket or driven elements 20, 21 (FIGS. 1 and 8-9), and for miscellaneous screw driving applications and the convenient removal of hub caps and tires 8, 80 (FIGS. 8, 9). It is preferable that the first and the second screwdriver heads 11, 12 each include a spring biased projection 15 formed or provided therein for engaging with the driven elements 20, 21 and for solidly and stably anchoring or retaining or positioning the driven elements 20, 21 to the screwdriver heads 11, 12 of the main wrench shaft member 10 and for preventing the driven elements 20, 21 from being disengaged or separated from the screwdriver heads 11, 12 of the main wrench shaft member 10 inadvertently.

The main wrench shaft member 10 includes an enlarged seat or block 16 formed or provided on the middle or intermediate portion 17 of the main wrench shaft member 10, and having an outer diameter greater than that of the main wrench shaft member 10, it is preferable that the length or distance (S) between the one or the first screwdriver head 11 and the block 16 is smaller or no greater than the length or distance (L) between the other or the second screwdriver head 12 and the block 16 for allowing the driven elements 20, 21 to be engaged into different depth of different tires 8, 80 (FIGS. 8, 9). The main wrench shaft member 10 includes a passage or bore 18 formed in the middle or intermediate portion 17 or the block 16 of the main wrench shaft member 10, and perpendicular to the main wrench shaft member 10, and includes a serrated or rough inner peripheral surface or member 19 formed or provided in the bore 18 of the block 16 of the main wrench shaft member 10 for frictionally engaging with an elongated leverage bar 30 which is inserted through the bore 18 of the block 16 of the main wrench shaft member 10 for providing a torque necessary to either tighten or loosen nuts or bolts 9, 90 (FIGS. 8, 9).

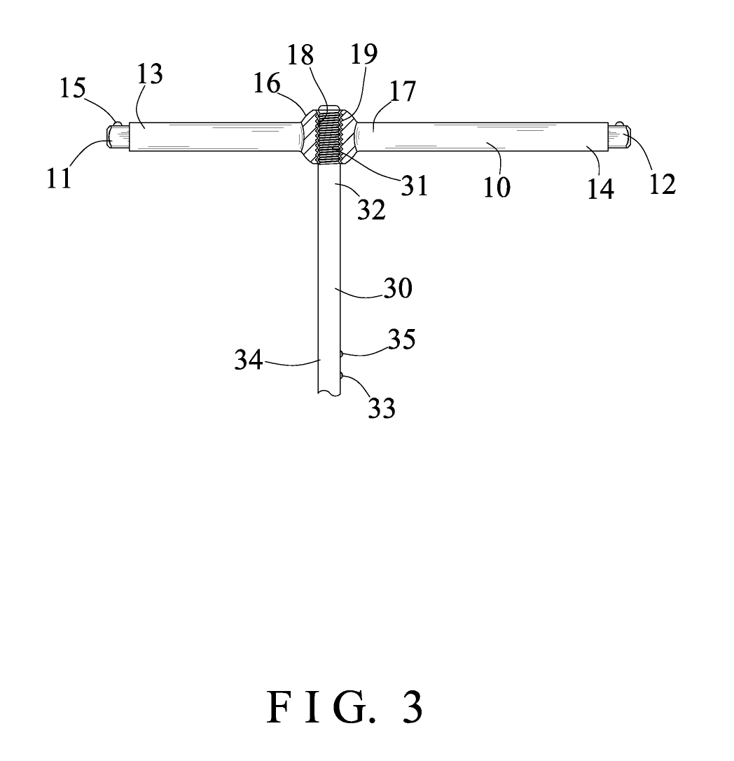

The elongated leverage bar 30 includes a serrated or rough outer peripheral surface or element 31 formed or provided on the one or first end portion 32 thereof for engaging into or through the bore 18 of the block 16 of the main wrench shaft member 10 and for rotating or driving the main wrench shaft member 10. As best shown in FIGS. 3 and 5-7, the outer diameter (d, FIG. 5) of the elongated leverage bar 30 is smaller or no greater than the inner diameter (D, FIG. 5) of the bore 18 of the block 16 of the main wrench shaft member 10 for allowing the first end portion 32 of the elongated leverage bar 30 to be freely inserted or engaged into or through the bore 18 of the block 16 of the main wrench shaft member 10. The rough member 19 of the main wrench shaft member 10 and the rough element 31 of the elongated leverage bar 30 may be selected from either a serrated surface or inner peripheral grooves and ridges or threads or threaded elements for frictionally engaging with each other.

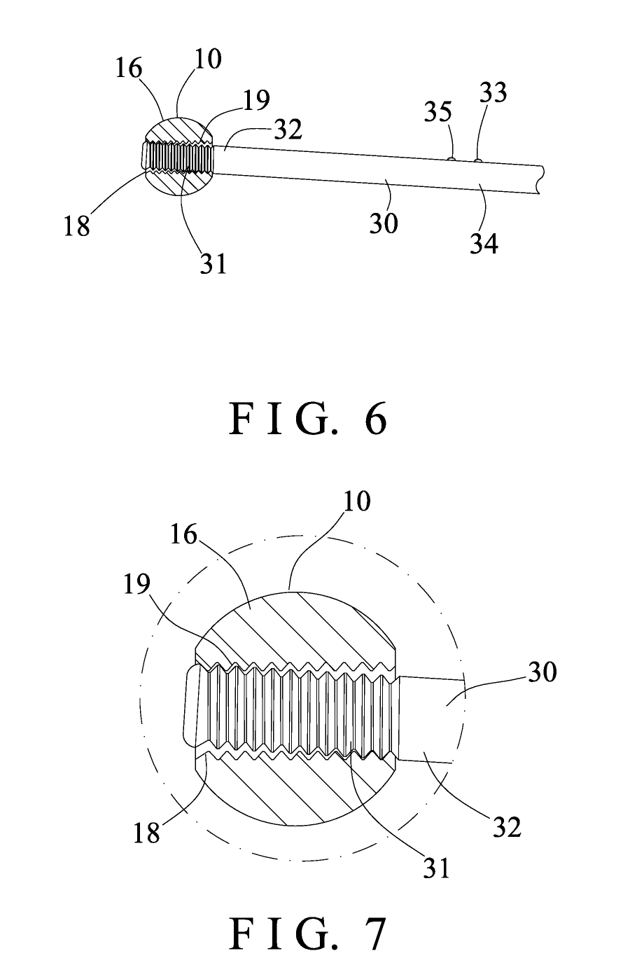

In operation, as shown in FIGS. 3 and 5-7, the first end portion 32 of the elongated leverage bar 30 may be freely inserted or engaged into or through the bore 18 of the block 16 of the main wrench shaft member 10 due to the difference between the outer diameter (d) of the elongated leverage bar 30 and the inner diameter (D) of the bore 18 of the block 16 of the main wrench shaft member 10. However, when the main wrench shaft member 10 is rotated or driven by the elongated leverage bar 30, the first end portion 32 of the elongated leverage bar 30 may be tilted or inclined relative to the block 16 of the main wrench shaft member 10, best shown in FIGS. 6-7, and the rough member 19 of the main wrench shaft member 10 may be solidly and stably and frictionally engaged with the rough element 31 of the elongated leverage bar 30, and thus for allowing the main wrench shaft member 10 to be solidly and stably and effectively or powerfully rotated or driven by the elongated leverage bar 30.

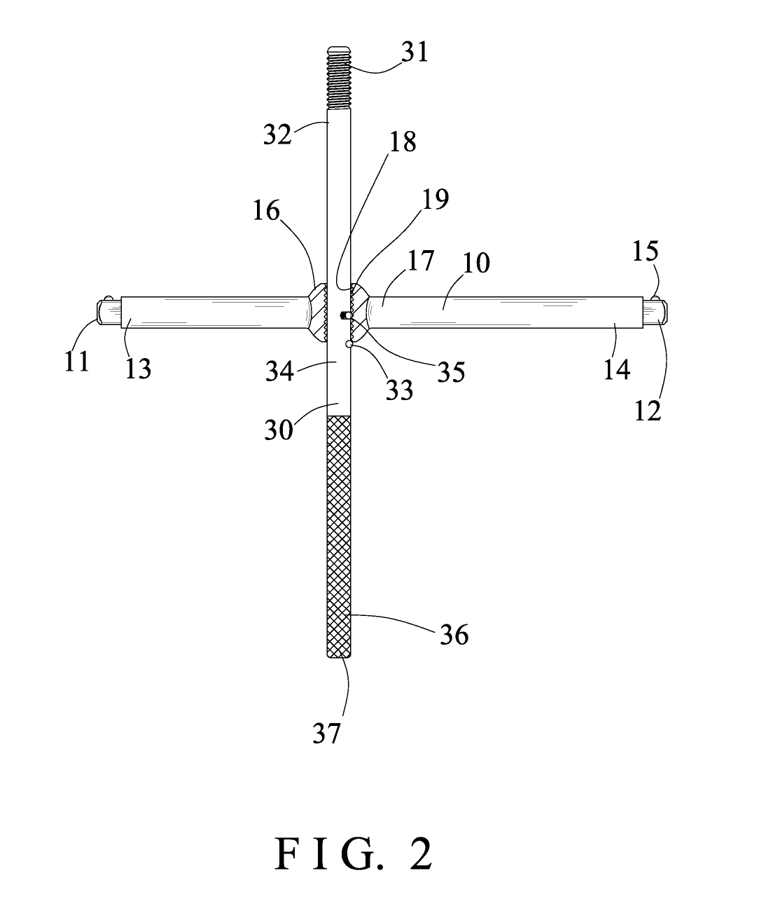

The elongated leverage bar 30 may include a key or stop 33 attached or mounted or secured thereto, such as attached to the middle or intermediate portion 34 of the elongated leverage bar 30 for selectively contacting or engaging with the block 16 or the main wrench shaft member 10 (FIG. 2) and for anchoring or retaining or positioning the elongated leverage bar 30 to the main wrench shaft member 10 and for guiding and limiting the elongated leverage bar 30 to slide or move relative to the main wrench shaft member 10. The elongated leverage bar 30 may further include a spring biased projection 35 formed or provided therein, such as formed or provided in the middle or intermediate portion 34 of the elongated leverage bar 30 for selectively engaging with the rough member 19 of the main wrench shaft member 10 and for further anchoring or retaining or positioning the elongated leverage bar 30 to the main wrench shaft member 10. The elongated leverage bar 30 may further include a serrated or rough or knurled hand grip 36 formed or provided on the other or the second end portion 37 of the elongated leverage bar 30 for being frictionally grasped or gripped or held by the user.

In operation, as shown in FIGS. 8 and 9, either of the driven elements 20, 21 may be selectively engaged into different depth of different tires 8, 80 for allowing the nuts or bolts 9, 90 to be easily and quickly and effectively tighten or loosen with the selected driven elements 20, 21. In addition, the rough member 19 of the main wrench shaft member 10 may be solidly and stably and frictionally engaged with the rough element 31 of the elongated leverage bar 30 for allowing the main wrench shaft member 10 to be solidly and stably and effectively rotated or driven by the elongated leverage bar 30, and thus for allowing the multi-purpose wrench tool to be solidly and stably and effectively actuated or operated by the user.

Accordingly, the multi-purpose wrench tool in accordance with the present invention includes an elongated leverage bar frictionally engageable with a main wrench shaft member with rough surfaces or members for providing a torque necessary to either tighten or loosen nuts or bolts and for allowing the main wrench shaft member to be effectively rotated or driven by the elongated leverage bar.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A multi-purpose wrench tool comprising:
a main wrench shaft member including a first screwdriver head provided at a first end of said main wrench shaft member for engaging with a driven element, said main wrench shaft member including a bore formed in an intermediate portion of said main wrench shaft member, and including a rough member provided in said bore of said main wrench shaft member, and
an elongated leverage bar including a rough element provided on a first end portion of said elongated leverage bar for engaging into said bore of said main wrench shaft member and for frictionally engaging with said rough member of said main wrench shaft member and for driving said main wrench shaft member with said elongated leverage bar.

2. The multi-purpose wrench tool as claimed in claim 1, wherein said elongated leverage bar includes an outer diameter (d) no greater than an inner diameter (D) of said bore of said main wrench shaft member for allowing said first end portion of said elongated leverage bar to be engaged into said bore of said main wrench shaft member.

3. The multi-purpose wrench tool as claimed in claim 1, wherein said main wrench shaft member includes a block provided on said intermediate portion of said main wrench shaft member, and said bore of said main wrench shaft member is formed in said block of said main wrench shaft member.

4. The multi-purpose wrench tool as claimed in claim 3, wherein said main wrench shaft member includes a second screwdriver head provided at a second end of said main wrench shaft member.

5. The multi-purpose wrench tool as claimed in claim 4, wherein a distance (S) between said first screwdriver head and said block is no greater than a distance (L) between said second screwdriver head and said block.

6. The multi-purpose wrench tool as claimed in claim 1, wherein said elongated leverage bar includes a stop attached thereto for selectively engaging with said main wrench shaft member and for guiding and limiting said elongated leverage bar to move relative to said main wrench shaft member.

7. The multi-purpose wrench tool as claimed in claim 1, wherein said elongated leverage bar includes a spring biased projection provided therein for selectively engaging with said rough member of said main wrench shaft member and anchoring said elongated leverage bar to said main wrench shaft member.

8. The multi-purpose wrench tool as claimed in claim 1, wherein said bore of said main wrench shaft member is perpendicular to said main wrench shaft member.

9. The multi-purpose wrench tool as claimed in claim 1, wherein said rough member of said main wrench shaft member is selected from a threaded element for frictionally engaging with said rough element of said elongated leverage bar.

10. The multi-purpose wrench tool as claimed in claim 1, wherein said rough element of said elongated leverage bar is selected from a threaded element for frictionally engaging with said rough member of said main wrench shaft member.
